(19) United States
(12) Patent Application Publication
(10) Pub. No.: US 2003/0080512 A1
(43) Pub. Date: May 1, 2003

(54) Very high-pressure cryogenic pump

(76) Inventor: Alain Colson, Saint Maur (FR)

Correspondence Address: YOUNG & THOMPSON, 745 SOUTH 23RD STREET 2ND FLOOR, ARLINGTON, VA, 22202

(21) Appl. No.: 09/780,515

(22) Filed: Feb. 12, 2001

(30) Foreign Application Priority Data
Feb. 11, 2000 (FR) 0001733

(51) Int. Cl. F16J 15/34

(52) U.S. Cl. 277/404

(57) ABSTRACT

In this pump, each sealing ring (14) of the piston (2) consists of two juxtaposed elementary rings (19A, 19B), the gaps of which are straight or angled and are offset, when fitting them, 180° with respect to one another, and of a common expander (21), and the elementary rings are made of a composite which contains more than 50% bronze and about 5% molybdenum disulphide, the rest being PTFE.

Application to continuously operating variable-capacity pumping of liquid nitrogen at pressures of 850 bar or more.

The present invention relates to a very high-pressure cryogenic pump of the type comprising a sleeve in which a sliding piston is housed, this piston being equipped near each end with a guide ring and, between the guide rings, with a number of sealing rings.

Cryogenic piston pumps are positive displacement pumps used to take a cryogenic liquid, in particular liquid nitrogen, to a high pump delivery pressure above the upper limit of centrifugal pumps, which is generally about 40 bar. These pumps are often supplied by a booster which delivers the input and the NPSH (Net Positive Suction Head) needed to prevent cavitation phenomena by sufficient subcooling of the liquid. In certain cases, these phenomena may be prevented by simply pressurizing the feed tank.

Cryogenic piston pumps used at the present time are provided with a number of simple sealing rings which are made of a material based on bronze-filled PPFE (polytetrafluoroethylene) and are provided with an internal expander. The gap of each ring may be straight or angled.

Experience shows that the mechanical behaviour of such rings, their positioning around the piston and their reliability are random in the very high-pressure range, typically between 200 and 1400 bar, when the operating conditions are severe: long period of continuous operation with a highly variable capacity or load, for example from 30 to 100% of the nominal output.

The object of the invention is to make the pump operate continuously and with a variable capacity for long periods, in the very high-pressure range, by limiting, on the one hand, the pump downtimes due to wear-induced degradation of the mechanical parts (rings, piston, sleeve in particular) and, on the other hand, the liquid losses due to an unsuitable design and to rapid mechanical degradation.

For this purpose, the subject of the invention is a cryogenic pump of the aforementioned type, characterized in that each sealing ring consists of two juxtaposed elementary rings, the gaps of which are straight or angled and are offset when fitting them, by 180° with respect to one another, and of a common expander, and in that the elementary rings are made of a composite which contains more than 50% bronze and about 5% molybdenum disulphide, the rest being PTFE.

The subject of the invention is also a piston for a cryogenic pump as defined above.

An embodiment of the invention will now be described with regard to the appended drawing in which:

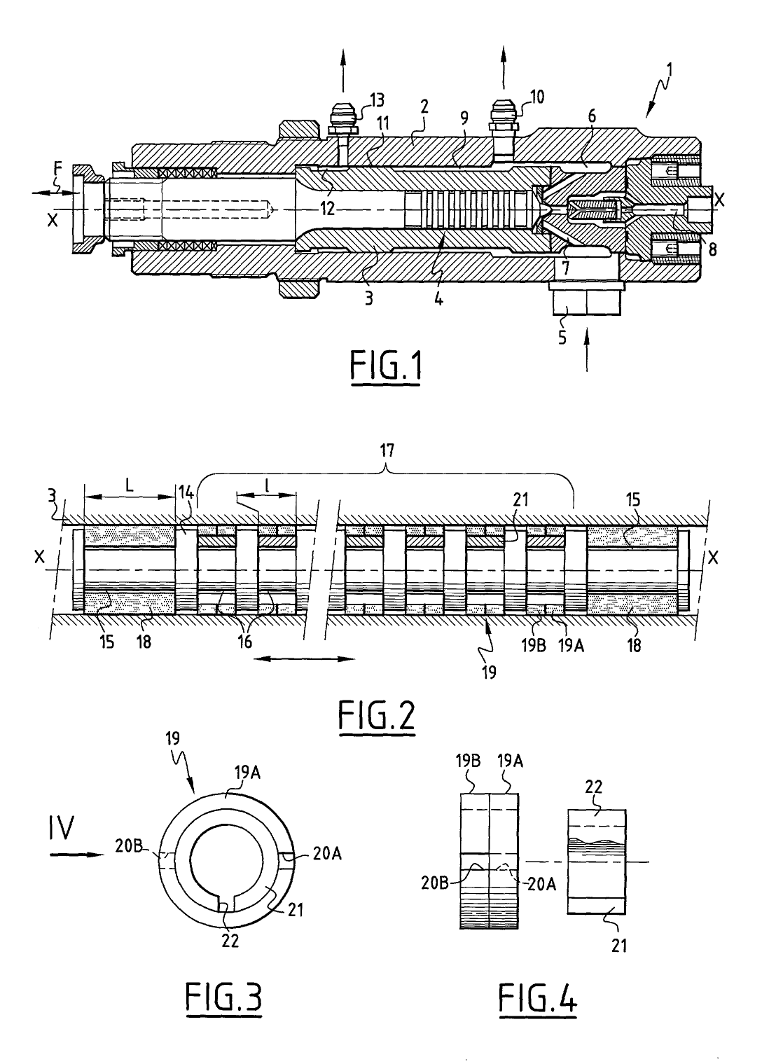

FIG. 1 is a partial schematic view in longitudinal section of a cryogenic pump according to the invention;

FIG. 2 is a similar view on a larger scale of the piston of this pump;

FIG. 3 is an end view of a sealing ring of this pump; and

FIG. 4 is a side view of the same sealing ring, with its expander axially offset in order to make the drawing clearer.

The cryogenic pump 1 shown schematically in FIG. 1 comprises a pump body 2 in which a sleeve 3 is fixed. A piston 4 slides in this sleeve in a reciprocating manner under the action of a drive system shown by a double arrow F.

With the exception of the piston rings, which will be described later, the structure of the pump is conventional. In service, the cryogenic liquid is injected under a sufficient low pressure, via an inlet fitting 5 provided with an inlet valve, into an annular chamber 6. When the piston moves back (to the left in FIG. 1), the liquid flows from the chamber 6 via the oblique ducts 7 into the sleeve 3. When the piston moves forwards, the liquid is pushed out under the high pressure through a delivery duct 8 via an outlet valve.

Excess liquid at the low pressure is permanently discharged by an annular space 9 in the body 2, which surrounds the sleeve 3, and from there via a fitting 10. The sleeve is centred in the body 2 by a land 11 lying to the left of the space 9, and an annular leak chamber 12 is provided to the left of the land 11. The leaking liquid gathered in the chamber 12 is discharged via a fitting 13.

The sleeve 1 has a central bore of circular cross section and its axis X-X is assumed to be horizontal, or slightly inclined upwards towards the outlet 8.

The piston 4 has an externally cylindrical body 14, of radius slightly less than the internal radius of the sleeve 3. This body is provided on the outside with two types of circular grooves: near each end, a groove 15 of relatively long length L and, between the two grooves 15, a number of grooves 16 of shorter length l. The grooves 16 together define a sealing region 17 of the piston.

Housed in each groove 15 is a guide ring 18 approximately of length L. This ring is a ring with a straight or angled gap and has longitudinal balancing slots on its external surface.

Housed in each groove 10 is a sealing ring 19 shown in FIGS. 2 and 3 in the rest state. This ring consists of two identical elementary rings 19A, 19B, with a straight gap 20A, 20B, as shown. Each elementary ring has a length of approximately l/2. The two elementary rings are juxtaposed and their gaps are offset angularly by 180° with respect to one another. Placed in each pair of rings 19A, 19B is an annular internal expander 21 slit with a straight gap, made of austenitic stainless steel or of any other equivalent material, having a length of approximately l. The axially oriented slit 22 of this expander is offset, when fitting it, by 90° with respect to those of the two elementary rings 19A and 19B.

The elementary rings are made of a hot-pressed sintered material composed of about 30% of PTFE, about 65% of bronze and about 5% of molybdenum disulphide MOS₂. The rings 18 are made of the same material.

In the fitted state, the circumferential clearance for each elementary ring 19A, 19B is less than 0.1 mm at the position of its gap, and the same applies for each guide ring 18.

The pump described above, with eight sealing rings 19 uniformly distributed along the length of the region 17, which is about 15 cm for a piston length of about 20 cm, has proved to be suitable for continuously operating without maintenance for at least 500 hours in periods of five days without stopping, with a delivery pressure of less than or equal to 850 bar and a capacity varying from 30 to 100%. This variation in capacity corresponds in this example to an average linear speed of the piston ranging from about 0.15 to 0.7 m/s. Such a range of average speeds, of less than 1 m/s, causes relatively little wear of the parts.

1. Very high-pressure cryogenic pump, of the type comprising a sleeve (3) in which a sliding piston (4) is housed, this piston being equipped near each end with a guide ring (18) and, between the guide rings, with a number of sealing rings (19), characterized in that each sealing ring consists of two juxtaposed elementary rings (19A, 19B), the gaps (20A, 20B) of which are straight or angled and are offset, when fitting them, by 180° with respect to one another, and of a common expander (21) and in that the elementary rings are made of a composite which contains more than 50% bronze and about 5% molybdenum disulphide, the rest being PTFE.

2. Cryogenic pump according to claim 1, characterized in that the composite contains about 65% bronze, about 5% molybdenum disulphide and about 30% PTFE.

3. Cryogenic pump according to claim 1, characterized in that the composite is sintered.

4. Cryogenic pump according to claim 1, characterized in that the expander (21) has a slit (32), especially a straight slit, which is offset, when fitting it, by 90° with respect to the gaps (20A, 20B) in the two elementary rings (19A, 19B).

5. Cryogenic pump according to claim 1, characterized in that the length (l) of each sealing ring (19) is less than that (L) of each guide ring (18).

6. Cryogenic pump according to claim 1, characterized in that, in the fitted state, the circumferential clearance for each elementary ring (19A, 19B) at the position of its gap (20A, 20B) is less than 0.1 mm.

7. Cryogenic pump according to claim 1, characterized in that the sealing rings (19) are uniformly distributed between the two guide rings (18).

8. Cryogenic pump according to claim 1, characterized in that the piston (4) has from five to twelve sealing rings.

9. Cryogenic pump according to claim 1, characterized in that the piston (4) has four sealing rings (19) for a high delivery pressure of between about 600 and about 90° bar.

10. Cryogenic pump according to claim 1, characterized in that the average linear speed of the piston (4) varies, depending on the pump's capacity, within a range whose upper limit is less than 1 m/s.

11. Cryogenic pump according to claim 1, characterized in that at least one guide ring (18) has longitudinal balancing slots on its external surface.

12. Cryogenic pump according to claim 11, characterized in that each guide ring (18) has longitudinal balancing slots on its external surface.

13. Cryogenic pump according to claim 1, characterized in that the sleeve (3) is surrounded by an annular space (9) in which, in service, cryogenic liquid flows.

14. Piston for a cryogenic pump, this piston being provided near each end with a guide ring (18) and, between the guide rings, a number of sealing rings (19), characterized in that each sealing ring consists of two juxtaposed elementary rings (19A, 19B), the gaps (20A, 20B) of which are straight or angled and are offset, when fitting them, by 180° with respect to one another, and of a common expander (21), and in that the elementary rings are made of a composite and which contains more than 50% bronze and about 5% molybdenum disulphide, the rest being PTFE.
